(19) United States
(12) Patent Application Publication
(10) Pub. No.: US 2011/0055872 A1
(43) Pub. Date: Mar. 3, 2011

(54) METHOD AND APPARATUS FOR REPRODUCING VIDEO DATA IN VIDEO DISTRIBUTION SYSTEM USING NETWORK

(76) Inventors: Takashi Narahara, Ome-shi (JP); Yasuhiro Fujiyoshi, Ome-shi (JP)

(21) Appl. No.: 12/939,021

(22) Filed: Nov. 3, 2010

Related U.S. Application Data
(63) Continuation of application No. 12/499,645, filed on Jul. 8, 2009.

(30) Foreign Application Priority Data
Oct. 31, 2008 (JP) 2008-282357

(51) Int. Cl. H04N 5/445

(52) U.S. Cl. 725/43; 725/41

(57) ABSTRACT

According to one embodiment, a video-data reproduction apparatus is connected by a network to a sever that distributes moving-picture content in unit of programs. The apparatus has a browser and a monitor. The browser can reproduce moving-picture content in units of programs, each at a time on the entire screen of the monitor. The browser performs a process of switching the program being reproduced on the entire screen, to a program designated, in accordance with an instruction input at a remote controller while the apparatus remains in the full-screen reproduction mode.

### CROSS-REFERENCE TO RELATED APPLICATIONS

This application is a continuation of U.S. patent application Ser. No. 12/499,645 filed Jul. 8, 2009, which is based upon and claims the benefit of priority on Japanese Patent Application No. 2008-282357, filed Oct. 31, 2008, the entire contents of which are incorporated herein by reference.

### BACKGROUND

1. Field

One embodiment of the present invention relates to a technique of receiving and reproducing content, such as video data, distributed in moving-picture distribution service that uses a network.

2. Description of the Related Art

In recent years, moving-picture distribution service has been promoted, which utilizes network represented by the Internet, along with the progress of digital broadcasting. Broadly practiced as a moving-picture distribution service is the so-called video on demand (VOD) service. (See, for example, Jpn. Pat. Appln. KOKAI Publication No. 2008-193284.)

In the moving-picture distribution service, a user terminal, such as a personal computer, reproduces a selection menu on the display screen, enabling the user to select any moving-picture content that has been transmitted via the network from a server (e.g., VOD server). To select desired moving-picture content, the user needs to perform a very complex operation at the input device in most cases.

Generally, in the moving-picture distribution service such as VOD that uses a network, the user must undergo a considerably complex procedure in order to select desired moving-picture content. More specifically, the user should switch the menu from the data-reproduction menu to the content-selection menu, while the moving-picture content selected is being reproduced.

In the moving-picture distribution service, too, it is desirable for the user that he or she can have the program (equivalent to moving-picture content) that he or she is viewing, smoothly to another, on the conventional TV receiver, by merely operating a remote controller or a similar device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of an apparatus for reproducing video data, according to an embodiment of this invention;

FIG. 2 is a flowchart explaining the sequence of reproducing video data in the embodiment of the invention;

FIGS. 3A to 3C are diagrams explaining how the embodiment reproduces video data; and

FIGS. 4A to 4C are diagrams explaining how images are switched from one to another while the embodiment is operating in the full-screen reproduction mode.

### DETAILED DESCRIPTION

Various embodiments according to the invention will be described hereinafter with reference to the accompanying drawings. In general, according to one embodiment of the invention, there is provided an apparatus for reproducing video data, which receives moving-picture content, using moving-picture distribution service utilizing a network, and which switches the moving-picture content being reproduced to other moving-picture content when the user performs a simple operation.

(Configuration of the System)

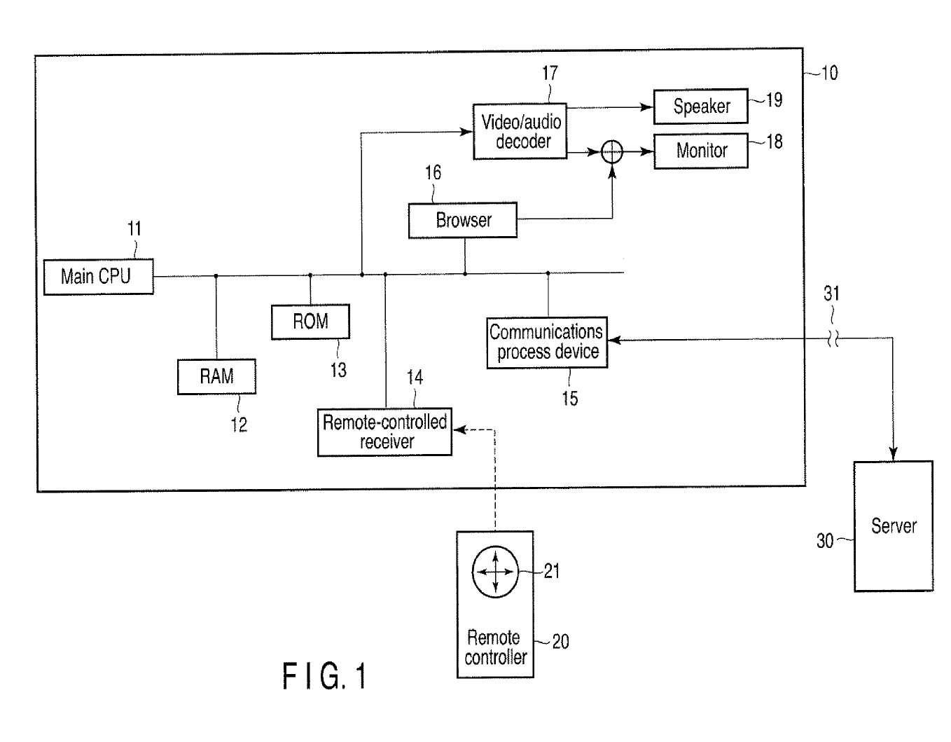

FIG. 1 is a block diagram that shows the major components of a video-data reproduction apparatus 10 for reproducing video data, according to an embodiment of the invention. To be more specific, the apparatus 10 is a digital television receiver having the function of receiving digital broadcast programs. Alternatively, the apparatus 10 may be a set-top box or an apparatus equivalent to a home server. In the apparatus 10 according to the present embodiment is a digital television receiver.

The video-data reproduction apparatus 10 has a main controller (main CPU) 11, a memory, and a remote-controlled receiver 14. The memory includes a random-access memory (RAM) 12 and a read-only memory (ROM) 13. The RAM 12 is a read/write memory for storing various data items that the main CPU 1 uses to process data, and operates as a buffer memory for storing stream data that is moving-picture content this embodiment reproduces. The ROM 13 stores programs including those the main CPU 11 executes.

The remote-controlled receiver 14 is receives an input operation signal transmitted from, for example, a remote controller 20 that is an input operation device. The receiver 14 transfers the input operation signal to a browser 16, which will be described later. The remote controller 20 transmits the input operation signal by virtue of wireless communication utilizing, for example, infrared lays. The remote controller 20 has not only various operation keys, but also a cross key 21 composed of an up segment, a down segment, a leftward segment and a rightward segment.

The video-data reproduction apparatus 10 further has a communications process device 15, a browser 16, a video/audio decoder 17, a monitor 18, and a speaker 19. The communications process device 15 is connected to a network 31, such as the Internet, to perform data communication via the network 31, thereby to exchange data (including moving-picture content) with a server 30.

The video/audio decoder 17 receives stream data (i.e., encoded video/audio stream content) transmitted from the server 30 and decodes the stream data. The monitor 18 is a display that reproduces, on the screen, the moving-picture content (i.e., video content) decoded by the video/audio decoder 17 and the content reproduced by the browser 16. The speaker 19 generates sound from the audio content decoded by the video/audio decoder 17.

The browser 16 is a module that performs a process of reproducing the video content. This process includes a program switching process, which will be explained later. That is, the browser 16 incorporated in this embodiment will be described as a browser module that is composed of a microprocessor (CPU) and software and configured to operated independently of the main CPU 11.

(Process of Reproducing the Video Content)

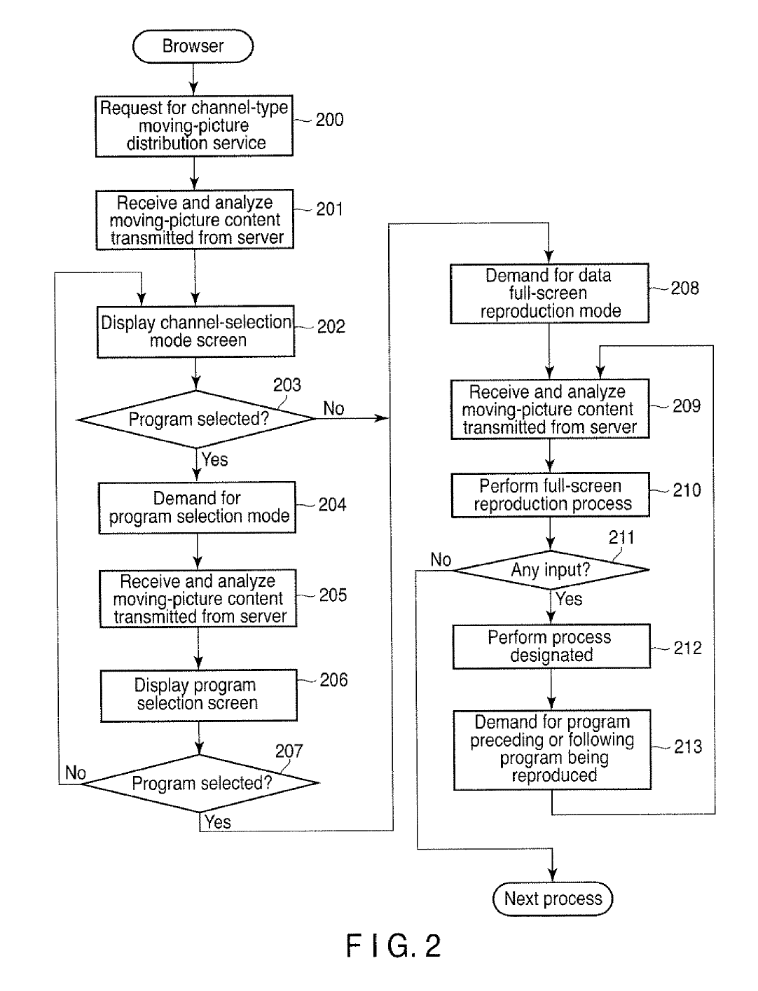

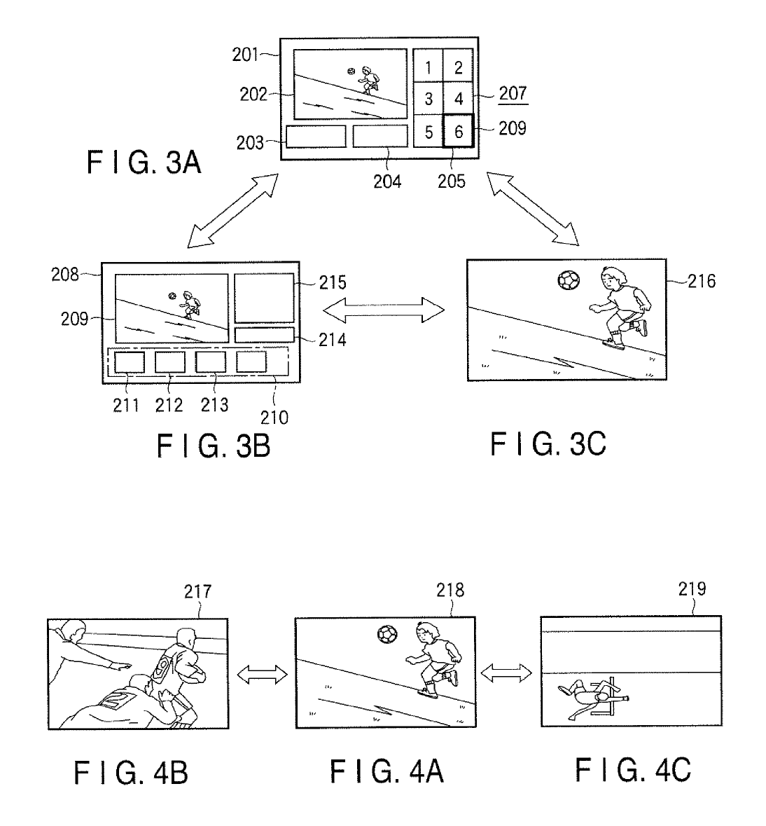

How the video-data reproduction apparatus 10 according to this embodiment operates will be explained with reference to the flowchart of FIG. 2, FIGS. 3A to 3C and FIGS. 4A to 4C.

It should first be noted that the video-data reproduction apparatus 10 has not only the function of receiving digital broadcast programs, but also the function of reproducing moving-picture content by virtue of the moving-picture distribution service utilizing the network 31. This is because the apparatus 10 has the components shown in FIG. 1. The server 30 accomplishes channel-type moving-picture distribution service in which the programs available take the form of VOD moving-picture content, the channels available are those shown in the playlist of moving-picture content, and the moving-picture content of any program selected is stream-transmitted. That is, each channel is composed a plurality of programs that should be broadcast at prescribed timeslots. In other words, each channel includes consecutive moving-picture content on the time axis, as if it was a sequence of digitally broadcast programs.

First, the user may push, for example, the dedicated button on the remote controller 20, demanding that the video-data reproduction apparatus 10 should perform the channel-type moving-picture distribution service. Then, the browser 16 receives the user's demand through the remote-controlled receiver 14 and informs the server 31 of this demand through the network 31 (Block 200).

Next, the browser 16 receives from the server 31 the data (i.e., content) about the sequence of operation that should be performed in order to receive the moving-picture distribution service from the server 30. On receiving this data, the browser 16 analyzes the content and performs a necessary process on the content (Block 201). The content transmitted from the server 30 at this point is, for example, data described in the hypertext markup language (HTML). The data contains video data representing still images and programs (software) called “scripts” to execute for various processes.

From the content transmitted from the server 30, the browser 16 generates a channel-selection mode screen 201, which is displayed by the monitor 18 (Block 202). As shown in FIG. 3A, the channel-selection mode screen 201 shows a window 202, buttons 203 and 204, and channels. In the window 202, a still picture (or moving picture) of the channel that has been selected. The button 203 may be touched to switch the operating mode to the program selection mode. The button 204 may be touched to switch the operating mode to the full-screen reproduction mode. Six channel buttons 207 are provided (for designating channels 1 to 6 in this embodiment). In the window 202, there may be displayed the video clip of, for example, the channel selected.

In the channel-selection mode screen 201, one of the channels 207, e.g., channel 6, is designated as indicated by number 205 shown in FIG. 3A, when user operates the down segment or up segment of the cross key 21 that is provided on the remote controller 20. The still picture for channel 6 is thereby reproduced and displayed in the window 202.

The user may touch the button 203 on the channel-selection mode screen 201. If this is the case (if Yes in Block 203), the browser 16 demands the server 30 for data that switches the operation mode to the program selection mode (Block 204). In response to the demand coming from the browser 16, the server 30 transmits the data (content) about the about-mentioned sequence of operation. The browser 16 receives and analyzes the content transmitted from the server 30 (Block 205) and causes the monitor 18 to display a program selection screen 208 (Block 206).

As FIG. 3B shows, the program selection screen 208 shows a window 209, a window 210, a button 214, and a window 215. The window 209 can display a still picture (or moving picture) of the program selected. The window 210 can display programs of the channel selected. The button 214 may be touched to switch the operating mode to the channel selection mode. The window 215 can display the program focused (i.e., in this instance, program 212 designated or selected in this instance). The window 210 for displaying programs selected includes three buttons 211, 212, and 213. The button 211 may be touched to display a still picture of the program being transmitted now. The button 212 may be touched to display a still picture of the program that will be transmitted next. The button 213 maybe touched to display a still picture of the third program to be transmitted. That is, the more rightward any one of these buttons 211 to 213 is located, the later the program associated with is transmitted on the time axis.

The user may operate the cross key 21 of the remote controller 20, designating the button 211 shown in the program selection screen 208 and thus selecting the program being transmitted now (if Yes in Block 207). In this case, a still picture of the program selected is reproduced in the window 209. The browser 16 then demands the server 30 for data that switches the operation mode to the full-screen reproduction mode (Block 208). At this point, one of the buttons displayed in the window 210 that in turned is displayed in the program selection screen 208 may be touched. In this case, any program other than the program being transmitted can be selected. The button 204 displayed in the channel-selection mode screen 201 may be touched to switch the operating mode to the full-screen reproduction mode. In this case, too, the browser 16 demands the server 30 for data that switches the operation mode to the full-screen reproduction mode.

The browser 16 receives and analyzes the moving-picture content transmitted from the server 30 (Block 209). The browser 16 then performs a full-screen reproduction process (Block 210). At this point, the server 30 transmits metadata that is necessary for reproducing the moving-picture content of the program. The metadata contains content-related data items such as the title of the moving-picture content and the size of the moving-picture content. The browser 16 analyzes the metadata and extracts from the metadata the data necessary for reproducing the moving-picture content.

In the full-screen reproduction mode, the video/audio decoder 17 decodes the stream data transmitted from the server 30, generating video content 216 and audio content. Note that in the stream data transmitted from the server 30, encoded video content and audio content are multiplexed with each other. The video content 216 generated by the decoder 17 is supplied to the monitor 18. The monitor 18 reproduces the video content 216 in the form of a full-screen image as shown in FIG. 3C. On the other hand, the audio content generated by the decoder 17 is supplied to the speaker 19. The speaker 19 converts the audio content to sound, thus reproducing the audio content. The full-screen image displayed, or full-screen content 216, may have upper and lower frames and/or left and lower frames. In other words, the video content may be displayed in the full-screen reproduction mode, occupying almost the entire screen of the monitor 18.

Thus, the full-screen reproduction process enables the user to view the moving-picture content of any program available on the channel selected (in this instance, the program being transmitted at present), on the monitor 18 in the full-screen reproduction mode as is illustrated in FIG. 3C. While viewing the moving-picture content in the full-screen reproduction mode, the user may want to view a program broadcast (transmitted) on the same channel, either before or after the program he or she is viewing.

With the present embodiment, the user can have the program switched another, merely by operating the remote controller 20 in a specific way. That is, the browser 16 can switch the program to another (Blocks 211 to 213), without reproducing the program selection screen 208. How the program is switched to another will be explained below in detail.

In this embodiment, the browser 16 switches the channel to another if the user operates the up or down segment of the cross key 21 on the remote controller 20, and switches the program to another if the user operates the left or right segment of the cross key 21. More specifically, if the user pushes the right segment of the cross key 21, the browser 16 will switch the program the user is viewing to the program that will be broadcast (transmit) next. On the other hand, if user pushes the left segment of the cross key 21, the browser 16 will switch the program the user is viewing now, to the program that immediately precedes on the time axis.

The browser 16 performs the process of switching the program to another, by using the script contained in the HTML data (i.e., the software for performing any designated process) when it receives and analyzes the moving-picture content transmitted from the server 30. More precisely, the browser 16 receives an instruction the user inputs by pushing the left segment of the cross key 21 on the remote controller 21 while the program 218 is displayed in the full-screen reproduction mode as illustrated in FIG. 4A (that is, Yes in Block 211). In response to this instruction supplied via the remote-controlled receiver 14, the browser 16 activates the script that has been designated, switching the program to the program the immediately precedes on the time axis (Block 212). That is, the browser 16 demands the server 30 for the full-screen reproduction mode in connection with the program broadcast (transmitted) that precedes, on the time axis, the program the user is viewing now (Block 213).

The browser 16 analyzes the moving-picture content of the program received from the server 30 (Block 209) and then performs the full-screen reproduction process (Block 210). In the full-screen reproduction process, the video/audio decoder 17 decodes the stream data transmitted from the server 30, as indicated above. The program is thereby switched from program 218 (FIG. 4A) being viewed, to program 217 broadcast (transmitted) prior to program 218, as is illustrated in FIG. 4B. Program 217 is therefore reproduced in the full-screen reproduction mode.

On the other hand, the user may push the right segment of the cross key 21 provided on the remote controller 20. In this case, the browser 16 activates the script that has been designated, switching the program to the program that immediately follows on the time axis (Block 212). That is, the browser 16 demands the server 30 for the full-screen reproduction mode in connection with the program broadcast (transmitted) that follows, on the time axis, the program the user is viewing now (Block 213).

The browser 16 analyzes the moving-picture content of the program received from the server 30 (Block 209) and then performs the full-screen reproduction process (Block 210). The program is thereby switched from program 218 (FIG. 4A) being viewed, to program 219 broadcast (transmitted) after program 218, as is illustrated in FIG. 4C. Program 219 is therefore reproduced in the full-screen reproduction mode.

As has been described, the present embodiment is a video-data reproduction apparatus that receives moving-picture content in units of programs distributed in channel-type moving-picture distribution service achieved via a network. In the embodiment, while being reproduced in the full-screen reproduction mode, the program selected can be smoothly switched to another program, without setting the apparatus back to the program selection mode. Hence, while viewing a program reproduced in the full-screen reproduction mode, the user can view a different program either preceding or following the program, in the full-screen reproduction mode, too, without the necessity of changing the screen mode. That is, the browser 16 keeps functioning while the moving-picture content is being reproduced in the full-screen reproduction mode. Thus, when the user operates the remote controller 20, inputting an instruction, the browser 16 automatically switches the program to another, while holding the apparatus 10 in the full-screen reproduction mode. Therefore, the user need not perform a troublesome operation, such as setting the operating mode back to the program selection mode, in order to switch the program to another. In other words, the user can switch the program to another, merely by performing an easy operation. In short, an easy operation on the part of the user suffices to switch the moving-picture content received by virtue of moving-picture distribution service achieved via a network, to other moving-picture content.

In the present embodiment, the cross key 21 of the remote controller 20 may be operated, inputting an instruction of switching the program to another. This instruction may be input by any other methods. For example, the monitor 18 may display an icon of a remote controller, which the user may touch to input the instruction. Alternatively, the user may operate the keyboard provided on the apparatus 10, thereby to input the instruction.

As described above, the program being viewed is switched to another broadcast on the same channel, either immediately preceding or following on the time axis in the present embodiment. The present invention is not limited to this. For example, the program may be switched to the first program broadcast on the same channel. Alternatively, code numbers may be assigned to the programs on the same channel, and the user may operate the ten-key pad of the remote controller, inputting the code number of a desired program and thereby switching the program to the desired one.

The embodiment described above is applied to digital TV receivers, set-top boxes or home servers. Nonetheless, it can, of course, be applied to personal computers.

Further, the present embodiment can be modified as will be described below.

Moving-picture content may be sorted in a specific method the user has registered beforehand and then arranged on the time axis, thereby preparing a moving-picture content list. The content shown in the list thus prepared may then be associated with the channels not used in the television broadcasting, thus setting favorite channels of the user. Such favorite channels can be set, also by changing the conditions of retrieving the vacant channels. Furthermore, a moving-picture content list can be prepared, not arranging the content on the time axis.

Thus, the user can view any content that meets the retrieval conditions he or she has set, as if there were a channel on which only such content is broadcast. When the user selects any desired channel, the content broadcast on this channel at the very time he or she selects the channel is reproduced. The user can thus enjoy viewing the content being broadcast on the channel he or she has just selected.

In this case, the content reproduced on the channel selected is not ordinary on-air content that the broadcasting station transmits on the time schedule. Rather, it is content that the server holds for the VOD service or content recorded in, for example, the HDD incorporated in, or provided outside, the video-data reproduction apparatus 10.

Hence, the user only needs to operate the remote controller to stop reproducing or temporarily stop reproducing, the content that is being reproduced. Now that the reproduction of the content has been stopped, the content can be fast rewound or fast fed, or played back in fast-rewind mode or fast-feed mode. It is enable the user to have any desired content allocated to a past timeslot or a future timeslot.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content reproduction apparatus comprising:
a communications module configured to be connected to a server that distributes moving-picture content in units of programs by use of a plurality of channels over a network, each channel including a plurality of programs that are consecutively reproducible on a time axis; and
a browser module configured to reproduce the moving-picture content on a display screen of a display apparatus, the browser module including:
a module configured to generate, based on information received from the server, a program selection menu on the display screen of the display apparatus to enable selection of a first program from among the plurality of programs transmitted over a channel of the plurality of channels;
a module configured to acquire moving-picture content of a program selected in the program selection menu and to execute full-screen reproduction which reproduces the moving-picture content on the entire display screen of the display apparatus; and
a module configured to perform, in accordance with an instruction supplied from an input module, a switching process of switching from the first program being displayed on the entire display screen to a second program of the plurality of programs scheduled for transmission before or after the first program over the channel, the second program being displayed on the entire display screen, wherein during the switching process, the browser module first acquires, from the server, the moving-picture content of the second program that precedes or follows the first program, on the time axis reproduces the moving-picture content on the entire display screen, and then executes the full-screen reproduction.

2. The content reproduction apparatus of claim 1, wherein the browser module executes software contained in the information received from the server, to thereby perform the switching process defined by the software, in accordance with the instruction supplied from the input module.

3. The content reproduction apparatus of claim 1, wherein the browser module is configured to execute the switching process such that the channels are switched in accordance with a first instruction supplied from the input module and the programs on the time axis are switched in accordance with a second instruction supplied from the input module.

4. The content reproduction apparatus of claim 3, wherein the input module comprises an up/down key and a right/left key, the first input instruction is executed by operating one of the up/down key and the right/left key, and the second input instruction is executed by operating another one of the up/down key and the right/left key.

5. The content reproduction apparatus of claim 1, wherein the browser module, when executing the full-screen reproduction, causes the moving-picture content to be decoded by a video/audio decoder.

6. The content reproduction apparatus of claim 1, wherein the browser module includes a module configured to generate a channel selection menu used for channel selection, based on the information received from the server, and the browser module is configured to generate the program selection menu used for selecting a program of a channel selected on the channel selection menu.

7. The content reproduction apparatus of claim 6, wherein the browser module is configured to acquire, from the server, moving-picture content on the channel selected in the channel selection menu and to execute the full-screen reproduction in accordance with an instruction supplied from the channel selection menu.

8. The content reproduction apparatus of claim 1, wherein the browser module is configured to generate, as the program selection menu, a screen including a window in which still-picture content of the selected program is displayed.

9. The content reproduction apparatus of claim 6, wherein the browser module is configured to generate, as the program selection menu, a screen including a window in which still-picture content of the selected program is displayed.

10. The content reproduction apparatus of claim 1, further comprising a broadcast reception module configured to receive digital broadcast video data.

11. The content reproduction apparatus of claim 1, further comprising:
a broadcast reception module configured to receive digital broadcast video data; and
an output module configured to output the moving-picture content and digital broadcast video data to a content reception apparatus that includes the display apparatus.

12. A content reproduction method applied to a content reproduction apparatus configured to be connected to a server that distributes moving-picture contents in units of programs by use of a plurality of channels over a network, each channel including a plurality of programs that are consecutively reproducible on a time axis, the method comprising:
generating, based on information received from the server, a program selection menu on a display screen of a display apparatus to enable selection of a first program from among the plurality of programs to be displayed on a channel of the plurality of channels;
acquiring moving-picture content of a program selected in the program selection menu from the server;
executing full-screen reproduction which reproduces the moving-picture content of the acquired program on the entire display screen of the display apparatus; and
performing, in accordance with an instruction supplied from an input module, a switching process of switching the first program of the plurality of programs being displayed on the entire display screen to a second program of the plurality of programs transmitted on the channel at a different time than the first program and displayed on the entire display screen, wherein the switching process including:
acquiring, from the server, the moving-picture content of the second program that precedes or follows the first program on the time axis,
reproducing the moving-picture content on the entire display screen, and
executing the full-screen reproduction.

13. In communications with a server to receive content over a plurality of channels, a content reproduction apparatus comprising:
a receiver;
a communications device adapted to receive content to be displayed on a selected channel of the plurality of channels, the content including a program assigned to a timeslot along a time axis and each of the plurality of channels being associated with a plurality of programs that are consecutively reproducible on the time axis; and
a processor to render the content for display on a display screen, the processor being adapted to switch, in accordance with an instruction supplied from an input module, rendering for display from a first program of the plurality of programs being received over the selected channel of the plurality of channels to a second program of the plurality of programs that either precedes or follows display of the first program along the time axis,
wherein during the switching process, the processor first acquires content associated with the second program and reproduces the content associated with the second program on the entire display screen.

14. The content reproduction apparatus of claim 13, wherein, in response to a first instruction supplied from the receiver, the processor determines if the first program is being displayed in a full-screen reproduction mode and executes a script provided with the content to switch from the first program to the second program following the first program along the time axis if the first program is being displayed in the full-screen reproduction mode.

15. The content reproduction apparatus of claim 14, wherein in response to a second instruction supplied from the receiver, the processor executes a script provided with the content to switch from the first program to a third program preceding the first program along the time axis if the first program is being displayed in the full-screen reproduction mode when the second instruction is detected by the processor.

16. The content reproduction apparatus of claim 13, wherein in response to a first instruction supplied from the receiver, the processor determines if the first program is being displayed in a full-screen reproduction mode and executes a script provided with the content to switch from the first program to the second program preceding the first program along the time axis if the first program is being displayed in the full-screen reproduction mode.

17. The content reproduction apparatus of claim 13, wherein the processor causes the content associated with the second program to be decoded by a decoder that generates video for display and audio corresponding to the video for playback.

18. The content reproduction apparatus of claim 13, wherein the processor is configured to generate for display a screen including a window in which an image of each of the plurality of programs arranged in accordance with the time axis.

19. The content reproduction apparatus of claim 18, wherein the processor to receive the instruction from the receiver to identify the second program being a selected one of the plurality of programs besides the first program currently being displayed in the full-screen reproduction mode.

20. The content reproduction apparatus of claim 13, wherein the processor is part of a browser being a module that performs a process of reproducing video content, the browser comprises the processor executing software independently of a second main processor within the content reproduction apparatus in order to switch from the first program and the second program upon receipt of the instruction from the receiver while the first program is being displayed in the full-screen reproduction mode.
